(19) United States
(12) Patent Application Publication
(10) Pub. No.: US 2015/0363502 A1
(43) Pub. Date: Dec. 17, 2015

(54) Optimizing personalized recommendations with longitudinal data and a future objective

(71) Applicant: Google Inc., Mountain View, CA (US)

(72) Inventors: Aiyou Chen, Palo Alto, CA (US); James Robert Koehler, Boulder, CO (US); Nicolas Remy, Louveciennes (FR); Makoto Uchida, Mountain View, CA (US)

(21) Appl. No.: 14/305,607

(22) Filed: Jun. 16, 2014

(51) Int. Cl. G06F 17/30

(52) U.S. Cl. CPC G06F 17/30876; G06F 17/30867

(57) ABSTRACT

Systems and techniques are provided for optimizing personalized recommendations with longitudinal data and a future objective. An identifier may be received for content items. A user content item history including a list identifying a previously acquired content item may be received. Content item metadata may be received including a correlation between the previously acquired content item and a content item for which an identifier was received, and a correlation between a content item for which an identifier was received and fulfillment of a future objective. A joint probability may be determined for each content item based on the user content item history and the content item metadata, including the probability that the content item will be acquired by the user after being recommended to the user and that a future objective will be fulfilled after the content item is acquired by the user.

### BACKGROUND

Users of a content ecosystem may acquire for use with their various computing devices, by downloading or requesting authorization to access, applications and other content, such as music, movies, TV shows, and electronic books. For example, a user may download and install applications on a smartphone, or gain authorization to access a music track on all computing devices to which the user is logged-in using their content ecosystem account. When a user searches through the various types of content available through the content ecosystem, he may discover several alternatives that match what he is looking for. For example, the user may wish to download a weather application to their smartphone. The content ecosystem may include several different weather applications, some of which may be free and some of which may need to be purchased.

The content ecosystem may make recommendations to the user as to what content the user should acquire. The recommendations may be made in response to a search by the user and may be based on the user's search query and other data available about the user, or may be made whenever the user browses through the content available through the content ecosystem. It may be in the financial interests of the application ecosystem to recommend content which needs to be purchased over free content. However, only recommending content which needs to be purchased may decrease the user's trust in and satisfaction with the application ecosystem, resulting in the user downloading or requesting authorization to access fewer items of content than were recommended by the content ecosystem. This may also result in lower ratings for content that the user does purchase. For example, the content ecosystem may recommend that the user install a weather application that needs to be purchased over a free weather application. The user may not trust that the recommended weather application is better than the free weather application if the user has noticed that the content ecosystem mostly recommends applications that need to be purchased.

### BRIEF SUMMARY

According to an embodiment of the disclosed subject matter an identifier may be received for two or more content items. A user content item history may be received for a user. The user content item history may include a list identifying a previously acquired content item. Content item metadata may be received including a correlation between the previously acquired content item and one of the content items for which an identifier was received, and a correlation between one of the content items for which an identifier was received and a fulfillment of a future objective. A joint probability may be determined for each of the two or more content items based on the user content item history and the content item metadata. The joint probability for one of the content items may include the probability that the content item will be acquired by the user after being recommended to the user and that a future objective will be fulfilled after the content item is acquired by the user. The content item identifier for the content item with the highest joint probability from the two or more content items may be sent to be viewed by the user.

Fulfilling the future objective may include the user rating the content item with the highest joint probability, the user reviewing the content item with the highest joint probability, the user recommending the content item with the highest joint probability, or the user purchasing another content item different from the content item with the highest joint probability within a specified timeframe. The content item may be an application, a music track, a music album, a TV show episode, a TV show season, or a movie.

The joint probability may be determined according to

P(Y=1|x₀,x₁, . . . ,xₜ)×Tₓ_{ₜ}ₓ_{ₜ₊₁}(1)+(1−P(Y=|x₀,x₁, . . . ,xₜ))Tₓ_{ₜ}ₓ_{ₜ₊₁}(0)

where x₀ is a null content item, x₁, . . . , xₜ is the user content item history, Y represents whether or not the future objective will be met, xₜ₊₁ is the content item for which the joint probability is being determined, Tₓ_{ₜ}ₓ_{ₜ₊₁}(0) is a transition probability when the future objective will not be met, Tₓ_{ₜ}ₓ_{ₜ₊₁}(1) is a transition probability when the future objective will be met, and x₀=0 represents when there are no content items in the user content item history.

Tₓ_{ₜ}_{d}_{ₜ₊₁}(1) may be determined according to P(Xₜ₊₁=k|Xₜ=j, Y=1) and Tₓ_{ₜ}ₓ_{ₜ₊₁}(0) may be determined according to P(Xₜ₊₁=k|Xₜ=j, Y=0).

P(Xₜ₊₁=k|Xₜ=j, Y=1) and P(Xₜ₊₁=k|Xₜ=j, Y=0) may be determined based on the user content item history and content item metadata. P(Y=1|x₀, x₁, . . . , xₜ) may be determined according to

$$\hat{P} ( Y = 1 \vert {x}_{1} , … , {x}_{t} ) = \frac{P ( Y = 1 ) {\prod }_{s = 0}^{t - 1} {r}_{{x}_{s} {x}_{s + 1}}}{P ( Y = 1 ) {\prod }_{s = 0}^{t - 1} {r}_{{x}_{s} {x}_{s + 1}} + P ( Y = 0 )} , and {r}_{{x}_{t} {x}_{t + 1}}$$

may be determined according to

$${r}_{jk} = \frac{P ( {X}_{t + 1} = k \vert {X}_{t} = j , Y = 1 )}{P ( {X}_{t + 1} = k \vert {X}_{t} = j , Y = 0 )} .$$

Sending the identifier for the content item with the highest joint probability may include sending the identifier to a content ecosystem application running on a client device. Sending the identifier for the content item with the highest joint probability may include sending the identifier in an email to an email account associated with the user. The user content item history may include longitudinal data for the user.

According to an embodiment of the disclosed subject matter, a means for receiving an identifier for each two or more content items, a means for receiving a user content item history for a user, where the user content item history may include a list identifying a previously acquired content item, a means for receiving content item metadata including at least one correlation between the previously acquired content item and the content items for which an identifier was received, and a correlation between one of the content items for which an identifier was received and a fulfillment of a future objective, a means for determining a joint probability for each of the two or more content items based on the user content item history and the content item metadata, where the joint probability for one of the content items may be the probability that the one of the content items will be acquired by the user after being recommended to the user and that a future objective will be fulfilled after the one of the content items is acquired by the user; and a means for sending the content item identifier for the content item with the highest joint probability from the at least two content items to be viewed by the user, are included.

Systems and techniques disclosed herein may allow for optimizing personalized recommendations with longitudinal data and a future objective. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example system suitable for optimizing personalized recommendations with longitudinal data and a future objective according to an implementation of the disclosed subject matter.

FIG. 2 shows an example arrangement for optimizing personalized recommendations with longitudinal data and a future objective according to an implementation of the disclosed subject matter.

FIG. 3 shows an example of a process for optimizing personalized recommendations with longitudinal data and a future objective according to an implementation of the disclosed subject matter.

FIG. 4 shows a computer according to an embodiment of the disclosed subject matter.

FIG. 5 shows a network configuration according to an embodiment of the disclosed subject matter.

### DETAILED DESCRIPTION

Recommendations of content items made to users of a content ecosystem may be optimized using longitudinal data about the user to increase the probability that the user will not only adopt the recommended content item, but will also fulfill some future objective, for example, exhibiting some desired future behavior such as purchasing a premium version of the same or another content item. The future objective may generally be to have the user take some second action in addition to acquiring the recommended content item. The content ecosystem may be used for the distribution of applications and other content, similar to an application ecosystem. For example, a storefront for the content ecosystem may present a user with an application recommendation. The application selected for recommendation to the user may be the application that has the highest joint probability of the user choosing to install the recommended application, based on the user's previously installed applications and metadata about the applications in the content ecosystem, and choosing to purchase another application within the next two weeks after adopting the recommended application. Recommending content items with a future objective may result in user's being recommended different content items than content items selected to maximize the probability that the user would adopt the recommended content item, or to maximize the monetization of the recommended content item. Longitudinal data may be used to determine what content item to recommend to a user based on the user's history of acquiring content items and correlations between other users' acquisitions of content items and fulfillment of future objectives after content item acquisitions, which may be found in content item metadata.

A user may use any suitable computing device, such as a smartphone, tablet, laptop, or smart television, to access the storefront for a content ecosystem. The storefront may be used by the content ecosystem for distribution of content items, including applications and other suitable content types of content items. The content items may be, for example, applications, music tracks and albums, e-books, movies, TV shows and other videos, or any other content suitable for electronic distribution. In some implementations, the content items may also be any purchasable item, including physical copies of media such as books, CD's, and DVD's, or other goods. The content items may also be recommendations, for example, for restaurants, shops, activities, travel locations, and so on. The content ecosystem may make recommendations to the user of which content items the users should acquire next. For example, the storefront displayed on the user's computing device may include a section with recommendations from among all of the content items distributed by the application system, or from different categories of the content items. For example, the storefront may display recommendations for what music the user should purchase next separately from recommendations for which applications the user should install next. The recommendations may also be linked to a search performed by the user. For example, the user may perform a search for weather applications, and search results which satisfy the search query for a weather application may be presented in a way that indicates some weather applications are being recommended over others. The content ecosystem may also use other communication channels to recommend content items to the user, for example, sending recommendations via email.

To select a content item to recommend to the user, the content ecosystem may evaluate the content items in the content ecosystem to determine the probability that the user will both adopt a recommended content item and, at some point in the future after adopting the recommended content item, behave in a desired manner, for example, purchasing a future content item. The recommendation may take into account longitudinal data about the user. The longitudinal data may be, for example, data indicating the user's previous acquisitions of content items and the order in which those acquisitions occurred. The longitudinal data may be, for example, a content item history for the user. The recommendation may also use metadata for the content items distributed by the content ecosystem. The content item metadata may include correlations between the acquisitions of different content item by users of the content ecosystem. The content item metadata may indicate how often users followed the acquisition of a first content item with a second content item, as found in the content item histories for the users of the content ecosystem, and how often a future objective was fulfilled after users acquired the second content item. For example, the content item metadata may indicate that 15% of users who installed a specific weather application next installed a specific travel application, and 5% of those users purchased an additional application within the next two weeks. The content item metadata may allow for the determination of transition probabilities between content items.

The recommendation made by the content ecosystem may maximize the joint probability that the user will adopt the recommended content item and that the user will behave in a desired manner in the future after adopting the recommended content item. The desired behavior may be a future objective, for example, having the user purchase a content item within the next two weeks, give a high rating to a content item, write a review of a content item, recommend a content item to a friend, or any other suitable second action on the part of the user that is in addition to the first action of the user acquiring the recommended application. Using a future objective in recommending the content item may prevent the content ecosystem from only recommending content items that the user needs to purchase, as the content ecosystem may recommend free content items which may result in increased probabilities of a future purchase by the user. This may also increase the user's satisfaction with both the content items and the content ecosystem, as users may be dissatisfied when they are mostly recommended content items that need to be purchased.

The content item to be recommended by the content ecosystem may be determined according to:

i=argmax_{iε{1, . . . ,N}}P(Y=1,Xₜ₊₁=i|Rₜ₊₁=i,Z,X₀,X₁, . . . ,Xₜ) (1)

where Xₜ₊₁ represents the next content item that the user will acquire, Rₜ₊₁ represents the content item that will be recommended to the user, Z represents demographic data about the user, X₀ may represent a null content item, X₁, . . . , Xₜ represents the longitudinal data, or content item history, for the user, Xₜ represents the most recent content item acquired by the user, Y represents whether or not the future objective will be met, with a value of 1 indicting the future objective will be met and a value of 0 indicating the future objective will not be met, N represents the number of content items distributed by the content ecosystem that the recommended application will be chosen from, and i represents the content item being evaluated.

According to (1), the content item recommended to the user by the content ecosystem may be the content item with the highest probability of being the content item that is acquired next by the user when recommended while still having the future objective fulfilled after the user acquires the recommended content item, given the user's demographic data and content item history. For example, a content item which will not result in the future objective being fulfilled may not be recommended even if the probability that the user will adopt the content item is 100%, as the content item's joint probability according to (1) would be 0% due to Y being equal to 0.

Based on (1), for any valid content item i:

P(Y=1,Xₜ₊₁=i|Rₜ₊₁=i,Z,X₁, . . . ,Xₜ)=P(Y=1,Xₜ₊₁=Rₜ₊₁|Z,X₀,X₁, . . . ,Xₜ), (2)

which allows (1) to be simplified to

i=argmax_{iεvalid-subset-of-{1, . . . ,N}}P(Y=1,Xₜ₊₁=i|Z,X₀,X₁, . . . ,Xₜ). (3)

The joint probability on the right-hand side of (3) may be decomposed into:

P(Xₜ₊₁=i|Z,X₁, . . . ,Xₜ)×P(Y=1|Z,X₀,X₁, . . . ,Xₜ,Xₜ₊₁=i) (4)

where the first term of the joint probability represents the probability that the user will adopt the content item i given the user's demographic data and content item history, and the second term of the joint probability represents the probability that the future objective will be fulfilled, for example, the user will take the desired second action, given the user's demographic data and content item history and given that the user has most recently acquired the recommended content item i. For any given user and content item i, the first term (4) may be the user's adoption probability for i, and the second term may be the user's future objective probability given adoption of the content item i.

Demographic data for the user, represented by Z, may be static, and may be omitted from derivations of the joint probabilities. The term xₜ may be a particular value that Xₜ may take. The term x₀ may be defined as 0, which may represent a null content item, and x_{1:t} may be an abbreviation of the vector x₁ . . . xₜ. Using Bayes theorem:

$$P ( Y = 1 \vert {x}_{0} , {x}_{1} , … , {x}_{t} ) = \frac{P ( {x}_{0} , {x}_{1} , … , {x}_{t} \vert Y = 1 )}{\begin{matrix}P ( {x}_{0} , {x}_{1} , … , {x}_{t} \vert Y = 1 ) P ( Y = 1 ) + \\ P ( {x}_{0} , {x}_{1} , … , {x}_{t} \vert Y = 0 ) P ( Y = 0 )\end{matrix}} . \qquad ( 5 )$$

According to the chain rule, for yε{0,1}:

P(x₀,x₁, . . . ,xₜ|Y=y)=Πₛ₌₁^{t}P(xₛ|Y=y,x₀, . . . ,xₛ₋₁) (6)

where y represents the possible outcomes for the future objective Y.

The complexity of the probability determination may therefore be concentrated on the ratio:

P(xₜ|Y=1,x₀, . . . ,xₜ₋₁)/P(xₛ|Y=0,x₀, . . . ,xₜ₋₁) (7)

There may be a strong autocorrelation between x₁, . . . , xₜ. For example, the content item xₜ may have a strong correlation with xₜ₋₁, and xₜ₊₁. The most recently acquired content item in a user's content item history, for example, the content item xₜ may serve as a proxy for the series of content item acquisitions previous to xₜ in the user's content item history, allowing for the evaluation of which content item to recommend next to be done according to:

P(xₜ|Y,x₀ . . . ,xₜ₋₁)≈P(xₜ|Y,xₜ₋₁) (8)

The probability may then be approximated by:

$$\hat{P} ( Y = 1 \vert {x}_{0} , {x}_{1} , … , {x}_{t} ) = \frac{P ( Y = 1 ) {\prod }_{s = 0}^{t - 1} {r}_{{x}_{s} {x}_{s + 1}}}{P ( Y = 1 ) {\prod }_{s = 0}^{t - 1} {r}_{{x}_{s} {x}_{s + 1}} + P ( Y = 0 )} \qquad ( 9 )$$

where \hat{P} may be the approximate probability for the content item xₜ₊₁ that the future objective will be fulfilled. rₓ_{ₜ}ₓ_{ₜ₊₁} may be evaluated based on:

$${r}_{jk} = \frac{P ( {X}_{t + 1} = k \vert {X}_{t} = j , Y = 1 )}{P ( {X}_{t + 1} = k \vert {X}_{t} = j , Y = 0 )} \qquad ( 10 )$$

Transition probabilities conditional on the value of Y may be evaluated according to:

Tⱼₖ(y)=P(Xₜ₊₁=k|Xₜ=j,Y=y) (11)

According to (11), (10) may be restated as:

rⱼₖ=Tⱼₖ(1)/Tⱼₖ(0) (12)

The transition probabilities according to (11) may be determined using content item histories from the users of the content ecosystem. For example, the number of times content items appear in sequence in the content item histories may be counted, and correlated with indications of fulfillment of the future objective. For example, the number of times a user of the content ecosystem purchased an application within two weeks of acquiring a specific application, in sequence with a specific previous application, may be counted. In the case of sparse data for content items, statistical techniques such as regularization may be used in the evaluation of the transition probabilities. (9), as evaluated using (10), (11), and (12), may be used to evaluate the future objective probability for any given user and content item.

Users of the content ecosystem may be divided into two subsets according to the potential outcomes for Y, which may be that the future objective was or was not fulfilled. The transition probabilities, as given in (11), may be dependent on the value of Y. The adoption probability may be decomposed according to:

P(Xₜ₊₁|X₀,X₁, . . . ,Xₜ)=Σ_{yε{0,1}}P(Y=y|X₀,X₁, . . . ,Xₜ)×P(Xₜ₊₁|Y=y,X₀,X₁, . . . ,Xₜ) (13)

The joint probability that a content item will both be adopted by the user when recommended and will lead to the fulfillment of the future object may then be evaluated according to:

P(Y=1|x₀,x₁, . . . ,xₜ)×Tₓ_{ₜ}ₓ_{ₜ₊₁}(1)+(1−P(Y=1|x₀,x₁, . . . ,xₜ))Tₓ_{ₜ}ₓ_{ₜ₊₁}(0) (14)

where P(Y=1|x₀, x₁, . . . ,xₜ) may be evaluated according to (9).

Equation (14) may be used to evaluate the joint probabilities for any subset of the content items in the content ecosystem that are being considered for recommendation to a user. The content item with the highest joint probability may be recommended to the user. For example, a content item may be determined to have an adoption probability when recommended to a specific user of 30%, and a future objective probability of 50%. The joint probability for the content item for the specific user may be 15%. This may indicate that when the content item is recommended to the specific user, there is a 15% chance that the user will both acquire the recommended content item and that the future objective will be fulfilled.

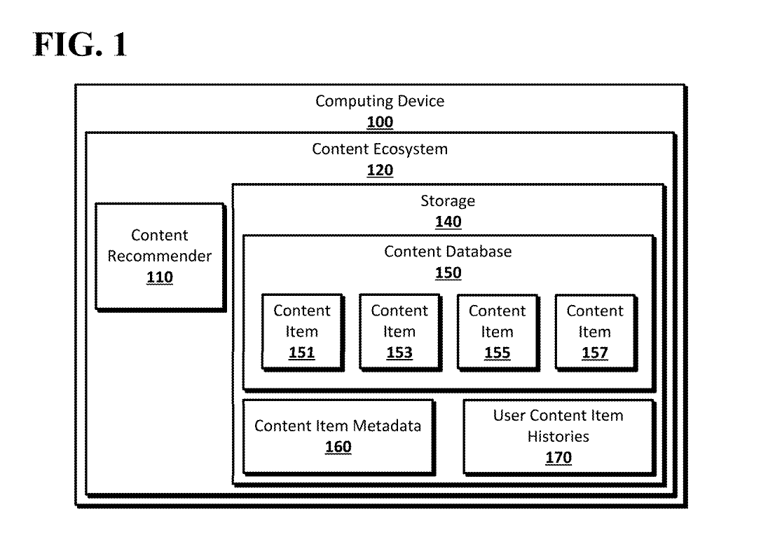

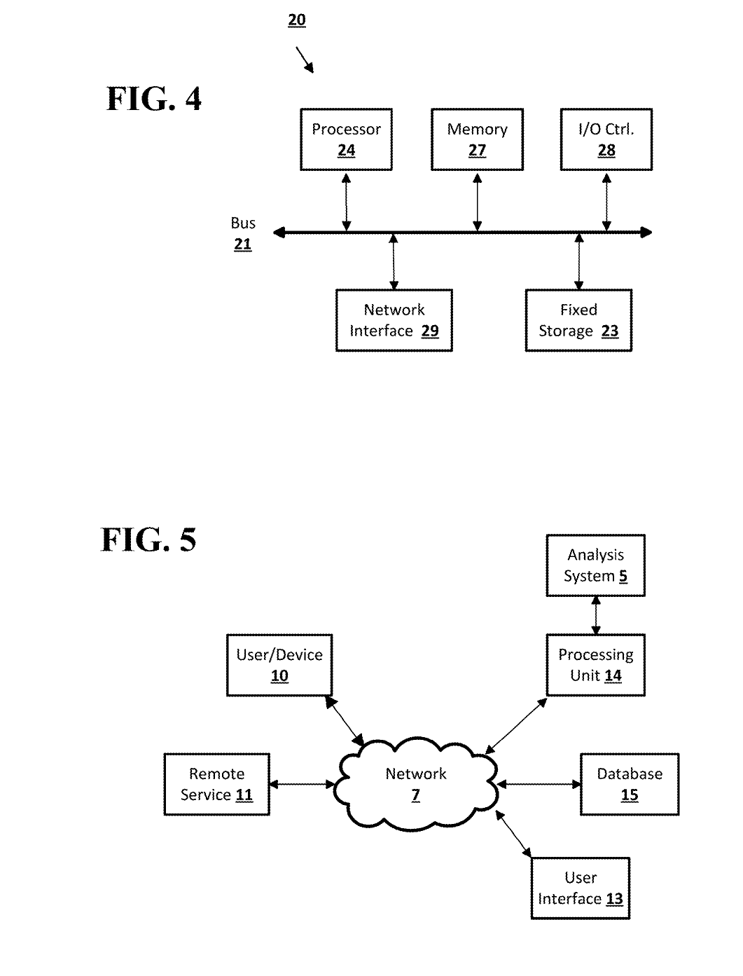

FIG. 1 shows an example system suitable for optimizing personalized recommendations with longitudinal data and a future objective according to an implementation of the disclosed subject matter. A computing device 100 may include a content ecosystem 120, which may include a content recommender 110 and storage 140. The computing device 100 may be any suitable device, such as, for example, a computer 20 as described in FIG. 4, for implementing the content recommender 110 and the storage 140. The computing device 100 may be a single computing device, or may include multiple connected computing devices, and may be, for example, a server that hosts a content ecosystem. The content recommender 110 may use the content item metadata 160 and user content item histories 170 to determine which content item 151, 153, 155, and 157 form the content database 150 to recommend to a user. The storage 140 may store the content database 150, the content item metadata 160, and the user content item histories 170.

The content ecosystem 120 may be, for example, similar to an application ecosystem, and may include content items other than applications. Users may use the content ecosystem 120 to acquire and manage their content items, for example, downloading and installing applications on the user's computing devices and gaining access to music and other media. Content items in the content ecosystem 120 may be acquired by the user for free, or may require the user to purchase them. The content database 150 may include content items, such as the content items 151, 153, 155, and 157, for distribution through the content ecosystem 120. For example, the content items 151, 153, 155, and 157 may be applications, music tracks, music albums, TV shows, movies, e-books, or any other type of content suitable for distribution through the content ecosystem 120.

The content item metadata 160 may include data indicating relationships between the various content items in the content database 150. The content item metadata 160 may indicate, for example, how often a particular content item is acquired by users immediately preceding another content item. For example, the content item metadata 160 may indicate that 25% of users who acquire the content item 153 next acquire the content item 151. The content item metadata 160 may also include indications of the fulfillment of future objectives by users after the acquisition of content items. For example, the content item metadata 160 may indicate how frequently users who installed an application wrote a review of the application, rated the application highly, recommended the application to a friend, or purchased another application, within two weeks of installing the application.

The user content item histories 170 may include longitudinal data for users of the content ecosystem 120. The longitudinal data may include the sequences of content item acquisitions by the users of the content ecosystem 120. For example, the user content item histories 170 may include, for a specific user, a sequence indicating that the user acquired, in order, the content item 155, the content item 157, and the content item 151. The user content item histories 170 may include records of user actions with regard to content items that may be related to future objectives. For example, the user content item histories 170 may include each time a user wrote a review of a content item, recommended a content item, rated a content item, or purchased a content item, and how long it took the user to perform these actions after acquiring the content item. For example, the user content item histories 170 for a specific user may indicate that the user acquired the content item 151, and three days later purchased the content item 153. The content item metadata 160 may be determined by counting the appearances of content items in sequence and instances of the fulfillment of future objectives in the user content item histories 170, for example, to allow for the evaluation of transition probabilities according to (11).

The content recommender 110 may be any suitable component of the content ecosystem 120 for recommending one of the content items, such as the content items 151, 153, 155, or 165, from the content database 150. The content recommender 110 may use the content item metadata 160 and the user content item histories 170 to determine which of the content items 151, 513, 155, and 157 to recommend based on probabilities evaluated according to (14).

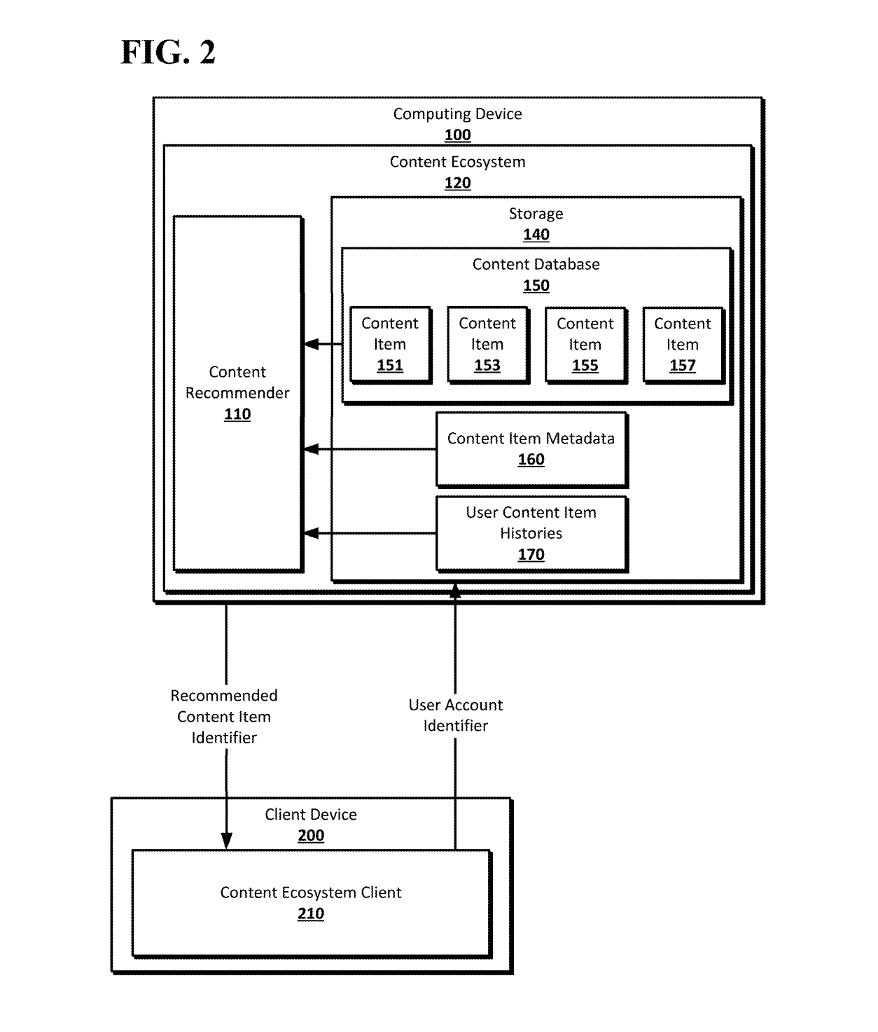

FIG. 2 shows an example arrangement for optimizing personalized recommendations with longitudinal data and a future objective according to an implementation of the disclosed subject matter. The client device 200 may be used to access the content ecosystem 120 on the computing device 100. The client device 200 may be any suitable computing device for use with the content ecosystem 120, such as, for example, a smartphone, tablet, laptop, desktop computer or smart television. A content ecosystem client 210 may be an application on the client device 200 used to access the content ecosystem 120, allowing the user to view and interact with the content ecosystem 120, for example, to acquire content items from the content database 150 and perform other functions related to content items, such as removing previously acquired content items, writing reviews of content items, rating content items, and recommending content items to other users.

A user account identifier, which may identify the account of the user using the content ecosystem client 210, may be sent to the content ecosystem 120 on the computing device 100. The content recommender 110 may use the user account identifier when determining which user content item history to use from the user content item histories 170, in order to determine which of the content items 151, 153, 155, and 157 the user last acquired from the content database 150. The content recommender 110 may use the user content item history from the user content item histories 170 and the content item metadata 160 to evaluate the joint probabilities for any subset of the content items in the content database 150 according to (14). For example, the content recommender 110 may evaluate the joint probabilities for all of the content items 151, 153, 155, and 157, which may, for example, all be applications. The content recommender 110 may also evaluate only a subset of the content items. For example, the user may navigate to a section of the content ecosystem client 210 that displays only one specific type of content, such as TV shows. The content recommender 110 may then only evaluate the content items 151 and 155, which may be TV shows, and not the content items 153 and 157, which may be applications.

The content recommender 110 may determine which of the evaluated content items has the highest joint probability according to (14), and recommend that content item to the user of the client device 200. The content recommender 110 may send an identifier to the client device 200 for the recommended content item which may be, for example, the name of the content item, an icon for the content item, or a link to a section of the content ecosystem client 210 where the content item can be acquired. For example, the content recommender 110 may determine that the content item 153 has the highest joint probability according to (14) of being both adopted by the user of the client device 200, and leading to fulfillment of the future objective after being adopted by the user. The content recommender 110 may send an identifier for the content item 153 to the client device 200, where the identifier may be displayed to the user through the content ecosystem client 210.

The content recommender 110 may also send recommendations to the client device 200 when the content ecosystem client 210 is not in use. For example, the content recommender 110 may send an email to an email address associated with the user of the client device 200 with content item recommendations, and may determine the appropriate user content item history based on an account associated with the email address.

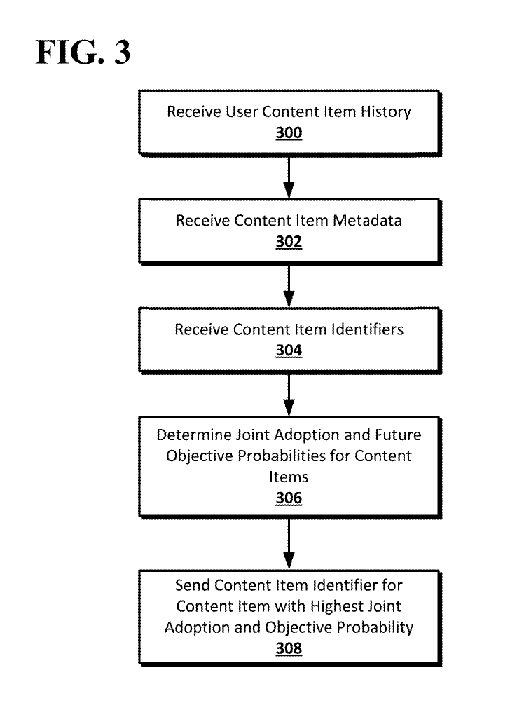

FIG. 3 shows an example of a process for optimizing personalized recommendations with longitudinal data and a future objective according to an implementation of the disclosed subject matter. At 300, a user content item history may be received. For example, the content recommender 110 may receive the user content item history for a user to whom a recommendation is being sent from the user content item histories 170. The correct user content item history may be identified based on a received user account identifier, or in any other suitable manner, such as, for example, based on an email address to which the recommendation will be sent. The content recommender 110 may extract the identity of the last acquired content item from the user content item history. If the user has not acquired any content items previously, the user content item history may include a null content item which may be used as the previously acquired content item.

At 302, content item metadata may be received. For example, the content recommender 110 may receive the content item metadata 160. The content recommender 110 may use the content item metadata 160 to evaluate correlations among various content items from the content database 150 and between the content items and fulfillment of future objectives.

At 304, content item identifiers may be received. The content recommender 110 may receive content item identifiers indicating which of the content items from the content database 150 the content recommender 110 will evaluate a joint probability for. The content item identifiers may allow the content recommender 110 to determine which data from the content item metadata 160 may be useful in the evaluation of the joint probability. For example, if the content recommender receives the content item identifiers for the content items 151, 153, and 155, but not for the content item 157, the content recommender 110 may not need any data from the content item metadata 160 concerning fulfillment of future objectives after the acquisition of the content item 157. No joint probability may be evaluated for the content item 157. The content item identifiers received by the content recommender 110 may include identifiers for all of the content items in the content database 150, or any subset of the content items, such as, for example, only content items that are applications.

At 306, the joint adoption and future objective probability may be determined for content items. For example, the content recommender 110 may use data from the user content item history, for example, the identity of the last content item acquired by the user, and the content item metadata 160 to determine the joint probability for the content items from the content database 150. The content recommender 110 may determine joint probabilities for all of the content items in the content database 150, or the subset of content items for which identifiers were received. For example, the content recommender may determine a joint probability for each of the content item 151, 153, 155, and 157. The joint probabilities may be determined according to (14).

At 308, the content item identifier for the content item with the highest joint adoption and future objective probability may be sent. For example, the content recommender 110 may send an identifier for the content item with the highest joint probability to the client device 200, to be displayed to the user in any suitable manner, for example, using the content ecosystem client 210, via email, or via any other suitable communications channel. For example, the content item 151 may have a joint probability of 25%, which may be higher than the joint probabilities for the content items 153, 155, and 157. The content recommender 110 may send an identifier for the content item 151 to the client device 200, as recommending the content item 151 to the user may result in the highest likelihood that the user will acquire the content item 151 and that the future objective will subsequently be fulfilled, for example, by the user purchasing a different content item within two weeks.

Embodiments of the presently disclosed subject matter may be implemented in and used with a variety of component and network architectures. FIG. 4 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 5.

Many other devices or components (not shown) may be connected in a similar manner, such as document scanners, digital cameras, auxiliary, supplemental, or backup systems, or the like. Conversely, all of the components shown in FIG. 4 need not be present to practice the present disclosure. The components can be interconnected in different ways from that shown. The operation of a computer such as that shown in FIG. 4 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 5 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-implemented method performed by a data processing apparatus, the method comprising:
receiving an identifier for each of at least two content items;
receiving a user content item history for a user, wherein the user content item history comprises a list identifying at least one previously acquired content item;
receiving content item metadata comprising at least one correlation between the at least one previously acquired content item and at least one of the content items for which an identifier was received, and at least one correlation between at least one of the content items for which an identifier was received and a fulfillment of a future objective;
determining a joint probability for each of the at least two content items based on the user content item history and the content item metadata, wherein the joint probability for one of the content items comprises the probability that the one of the content items will be acquired by the user after being recommended to the user and that a future objective will be fulfilled after the one of the content items is acquired by the user; and
sending the content item identifier for the content item with the highest joint probability from the at least two content items to be viewed by the user.

2. The computer-implemented method of claim 1, wherein fulfilling the future objective comprises at least one of: the user rating the content item with the highest joint probability, the user reviewing the content item with the highest joint probability, the user recommending the content item with the highest joint probability, and the user purchasing another content item different from the content item with the highest joint probability within a specified timeframe.

3. The computer-implemented method of claim 1, wherein the content item is an application, a music track, a music album, a TV show episode, a TV show season, or a movie.

4. The computer-implemented method of claim 1, wherein the joint probability is determined according to:
P(Y=1|x₀,x₁, . . . ,xₜ)×Tₓ_{ₜ}ₓ_{ₜ₊₁}(1)+(1−P(Y=1|x₀,x₁, . . . ,xₜ))Tₓ_{ₜ}ₓ_{ₜ₊₁}(0),
wherein x₀ is a null content item, x₁, . . . , xₜ is the user content item history, Y represents whether or not the future objective will be met, xₜ₊₁ is the content item for which the joint probability is being determined, Tₓ_{ₜ}ₓ_{ₜ₊₁}(0) is a transition probability when the future objective will not be met, Tₓ_{ₜ}ₓ_{ₜ₊₁}(1) is a transition probability when the future objective will be met, and x₀=0 represents when there are no content items in the user content item history.

5. The computer-implemented method of claim 4, wherein Tₓ_{ₜ}ₓ₊₁(1) is determined according to P(Xₜ₊₁=k|Xₜ=j,Y=1) and Tₓ_{ₜ}ₓ_{ₜ₊₁}(0) is determined according to P(Xₜ₊₁=k|Xₜ=j, Y=0).

6. The computer-implemented method of claim 5, wherein P(Xₜ₊₁=k|Xₜ=j, Y=1) and P(Xₜ₊₁=k|Xₜ=j, Y=0) are determined based on the user content item history and content item metadata.

7. The computer-implemented method of claim 4, wherein P (Y=1|x₀, x₁, . . . , xₜ) is determined according to
$$\hat{P} ( Y = 1 \vert {x}_{0} , {x}_{1} , … , {x}_{t} ) = \frac{P ( Y = 1 ) {\prod }_{s = 0}^{t - 1} {r}_{{x}_{s} {x}_{s + 1}}}{P ( Y = 1 ) {\prod }_{s = 0}^{t - 1} {r}_{{x}_{s} {x}_{s + 1}} + P ( Y = 0 )} ,$$
and rₓ_{ₜ}ₓ_{ₜ₊₁} is determined according to
$${r}_{jk} = \frac{P ( {X}_{t + 1} = k \vert {X}_{t} = j , Y = 1 )}{P ( {X}_{t + 1} = k \vert {X}_{t} = j , Y = 0 )} .$$

8. The computer-implemented method of claim 1, wherein sending the identifier for the content item with the highest joint probability comprises sending the identifier to a content ecosystem application running on a client device.

9. The computer-implemented method of claim 1, wherein sending the identifier for the content item with the highest joint probability comprises sending the identifier in an email to an email account associated with the user.

10. The computer-implemented method of claim 1, wherein the user content item history comprises longitudinal data for the user.

11. A computer-implemented system for optimizing personalized recommendations with longitudinal data and a future objective:
a storage comprising a content database, the content database comprising content items, user content item histories, and content item metadata; and
a content recommender adapted to receive a user account identifier that identifies a user, a user content item history associated with the user from the user content item histories, the content item metadata, and content item identifiers for at least two of the content items from the content database, evaluate a joint probability for each of the at least two content items based on the user content item history and the content item metadata, and send an identifier for the content item with the highest joint probability from the at least two content items to the user.

12. The computer-implemented system of claim 11, wherein the joint probability for one of the content items comprises a probability that the user will acquire the one of the content items and a future objective will be fulfilled after the user acquires the one of the content items.

13. The computer-implemented system of claim 11, wherein the user content item history comprises a list identifying at least one previously acquired content item.

14. The computer-implemented system of claim 11, wherein the content item metadata comprises at least one correlation between two content items from the content database, and at least one correlation between at least one of the content items from the content database and fulfillment of a future objective

15. The computer-implemented system of claim 12, wherein fulfilling the future objective comprises at least one of: the user rating the content item with the highest joint probability, the user reviewing the content item with the highest joint probability, the user recommending the content item with the highest joint probability, and the user purchasing another content item different from the content item with the highest joint probability within a specified timeframe.

16. The computer-implemented system of claim 11, wherein the content item is an application, a music track, a music album, a TV show episode, a TV show season, or a movie.

17. The computer-implemented system of claim 11, wherein the joint probability is determined according to:
P(Y=1|x₀,x₁, . . . ,xₜ)×Tₓ_{ₜ}ₓ_{ₜ₊₁}(1)+(1−P(Y=1|x₀,x₁, . . . ,xₜ))Tₓ_{ₜ}ₓ_{ₜ₊₁}(0),
wherein x₀ is a null content item, x₁, . . . , xₜ is the user content item history, Y represents whether or not the future objective will be met, xₜ₊₁ is the content item for which the joint probability is being determined, Tₓ_{ₜ}ₓ_{ₜ₊₁}(0) is a transition probability when the future objective will not be met, Tₓ_{ₜ}ₓ_{ₜ₊₁}(1) is a transition probability when the future objective will be met, Tₓ_{ₜ}ₓ_{ₜ₊₁} is a transition probability, and x₀=0 represents when there are no content items in the user content item history.

18. The computer-implemented system of claim 17, wherein Tₓ_{ₜ}ₓ_{ₜ₊₁}(1) is determined according to P(Xₜ₊₁=k|Xₜ=j, Y=1) and Tₓ_{ₜ}ₓ_{ₜ₊₁}(0) is determined according to P(Xₜ₊₁=k|Xₜ=j, Y=0).

19. The computer-implemented system of claim 18, wherein P(Xₜ₊₁=k|Xₜ=j, Y=1) and P(Xₜ₊₁=k|Xₜ=j, Y=0) are determined based on the user content item history and content item metadata.

20. The computer-implemented system of claim 17, wherein P (Y=1|x₀, x₁, . . . ,xₜ) is determined according to
$$\hat{P} ( Y = 1 \vert {x}_{0} , {x}_{1} , … , {x}_{t} ) = \frac{P ( Y = 1 ) {\prod }_{s = 0}^{t - 1} {r}_{{x}_{s} {x}_{s + 1}}}{P ( Y = 1 ) {\prod }_{s = 0}^{t - 1} {r}_{{x}_{s} {x}_{s + 1}} + P ( Y = 0 )} ,$$
and rₓ_{ₜ}ₓ_{ₜ₊₁} is determined according to
$${r}_{jk} = \frac{P ( {X}_{t + 1} = k \vert {X}_{t} = j , Y = 1 )}{P ( {X}_{t + 1} = k \vert {X}_{t} = j , Y = 0 )} .$$

21. The computer-implemented system of claim 11, wherein the content recommender is further adapted to send the identifier for the content item with the highest joint probability to a content ecosystem application running on a client device.

22. The computer-implemented method of claim 11, wherein the content recommender is further adapted to send the identifier for the content item with the highest joint probability in an email to an email account associated with the user.

23. A system comprising: one or more computers and one or more storage devices storing instructions which are operable, when executed by the one or more computers, to cause the one or more computers to perform operations comprising:
receiving an identifier for each of at least two content items;
receiving a user content item history for a user, wherein the user content item history comprises a list identifying at least one previously acquired content item;
receiving content item metadata comprising at least one correlation between the at least one previously acquired content item and at least one of the content items for which an identifier was received, and at least one correlation between at least one of the content items for which an identifier was received and fulfillment of a future objective;
determining a joint probability for each of the at least two content items based on the user content item history and the content item metadata, wherein the joint probability for one of the content items comprises the probability that the one of the content items will be acquired by the user after being recommended to the user and that a future objective will be fulfilled after the one of the content items is acquired by the user; and
sending the content item identifier for the content item with the highest joint probability from the at least two content items to be viewed by the user.
